(19) United States
(12) Patent Application Publication
(10) Pub. No.: US 2013/0170893 A1
(43) Pub. Date: Jul. 4, 2013

(54) Magnetic-Mechanical Connection Assembly and Writing Instrument Comprising Same

(71) Applicants: David Martin, Glynde Nr Lewes (GB); Leighton Davies-Smith, Founex (CH)

(72) Inventors: David Martin, Glynde Nr Lewes (GB); Leighton Davies-Smith, Founex (CH)

(73) Assignee: PARKER PEN PRODUCT, East Sussex (GB)

(21) Appl. No.: 13/340,267

(22) Filed: Dec. 29, 2011

(51) Int. Cl. B43K 15/00; B43K 5/00

(52) U.S. Cl. 401/251

(57) ABSTRACT

A writing instrument includes a nose section that is releasably connected to a barrel housing portion that contains an ink reservoir, in the form of a replaceable cartridge, for holding ink for delivery to a writing nib. The nose section is releasably connected to the barrel housing portion with a magnetic-mechanical connection assembly to allow easy access to the replaceable cartridge.

### BACKGROUND

1. Field of the Invention

The invention generally relates to a writing instrument with a magnetic-mechanical connection assembly and more specifically to a writing instrument having a magneticmechanical connection assembly releasably securing a nose section to a barrel housing portion.

2. Related Technology

Conventional writing instruments typically have a replaceable ink cartridge disposed in a barrel housing portion for easy replenishment of ink. Often the nose section is a separate component that is releasably secured to a barrel housing portion of the writing instrument.

Generally, known writing instruments use one of two different connection mechanisms to releasably secure the nose section to the barrel housing portion.

First, some known writing instruments use a threaded connection where the nose section is screwed onto the barrel housing portion. This type of threaded connection, while being secure, can be somewhat cumbersome for a consumer to use. Initially, the consumer must align the nose section with the barrel housing portion and then the nose section must be rotated through several revolutions to a secured position. The reverse operation is needed to remove the nose section from the barrel housing portion for replacement of the ink cartridge. This threaded connection is therefore somewhat time consuming and inefficient to use. Additionally, the threaded connection can easily become damaged if the threads are improperly aligned prior to and/or during rotation.

A second type of connection is an interference connection that uses offset ridges, usually a first ridge on the outside of the nose section and a second ridge on the inside of the barrel connection portion. A consumer aligns the nose section and the barrel housing portion and pushes the nose section until the second ridge slides over the first ridge to provide a secured position between the nose section and the barrel housing portion. This type of connection is often called a “snap-fit” connection. While this type of connection is quicker to use, it is also more susceptible to inadvertent dislodgement as it is inherently weaker than the threaded connection. Additionally, this type of connection is prone to weakening (due to material loss from repeated frictional engagement) or warping over time.

### SUMMARY

An instrument comprises a nose section having a hollow channel and a first opening at one end of the hollow channel. A barrel housing portion has an interior, the nose section being at least partially disposed within the interior of the barrel housing portion. A magnetic-mechanical connection assembly between the nose section and the barrel housing portion provides magnetic and mechanical force to secure the nose section to the barrel housing portion. The magnetic-mechanical connection assembly includes at least one bayonet pin disposed on one of the nose section and the barrel housing portion and at least one locking channel disposed on the other of the nose section and the barrel housing portion.

In another embodiment, a writing instrument comprises a nose section having an opening at one end. A writing nib extends through the opening. A barrel housing portion is connected to the nose section opposite of the writing nib, the barrel housing portion having an ink reservoir for holding ink to be delivered to the writing nib. A magnetic-mechanical connection assembly provides connection force for releasably connecting the nose section to the barrel housing portion. The magnetic-mechanical connection assembly includes at least one nose magnet disposed on the nose section, at least one barrel housing magnet disposed on the barrel housing portion, at least one locking channel formed in an inner surface of the barrel housing portion, and at least one bayonet pin formed on an outer surface of the nose section, the bayonet pin being sized and shaped to fit within the locking channel to mechanically secure the nose section to the barrel housing portion, such that the barrel housing magnets and the nose magnets are aligned to provide an attractive force therebetween.

### BRIEF DESCRIPTION OF THE DRAWINGS

Further features and advantages of the invention can be gathered from the claims, the following description, and the attached diagrammatic drawings, wherein:

FIG. 1 is a perspective view of a first embodiment of a writing instrument having a magnetic-mechanical connection assembly between a nose section and a barrel housing portion;

FIG. 2 is a close-up exploded perspective view of the magnetic-mechanical connection assembly of FIG. 1;

FIG. 3 is a plan view of a ring magnet that may be used in the magnetic-mechanical connection assembly of FIG. 2;

FIGS. 4 and 5 are perspective views of two ring magnets of FIG. 3 in various orientations with respect to one another, generally illustrating the repelling and attractive forces generated during rotation;

FIG. 6 is a perspective view of a second embodiment of a writing instrument having a magnetic-mechanical connection assembly between the nose section and the barrel housing portion;

FIG. 7 is a close-up perspective view of the magnetic-mechanical connection assembly of FIG. 6;

FIG. 8 is a schematic plan view of the magnetic-mechanical connection assembly of FIG. 7 when assembled and the components are rotated into a locked position; and

FIG. 9 is a schematic view of an alternate arrangement of magnets used in the magnetic-mechanical connection assembly of FIG. 7 when assembled and the components are rotated into a locked position.

### DETAILED DESCRIPTION

The disclosed writing instrument advantageously includes a magnetic-mechanical connection assembly between a nose section and a barrel housing portion, the magneticmechanical connection assembly having an opening force that is greater than the magnetic force generated between magnets alone in the magnetic-mechanical connection assembly because a mechanical interaction must also be overcome. The writing instrument relies on magnetic field attraction for a motive force to pull or twist the nose section into a secured position with respect to the barrel housing portion. The magnetic field attraction also provides continuing motive force to maintain the nose section in the secured position. This magnetic field attraction must be overcome by a consumer to release the nose section from the barrel housing portion. Thus, the writing instrument described herein advantageously provides a consumer with a closure system that includes a quick-release connection having a tactile sensation that indicates a secured position. The quick-release connection allows the nose section to be quickly secured to, or released from, the barrel housing portion.

A fountain pen 10 is exemplified in the drawings, however, other writing instruments including, but not limited to markers, highlighters, ball pens, felt tip pens, and other fluid application devices including, but not limited to, correction fluid applicators and paint applicators could also be made in accordance with the teachings of the disclosure by selection of appropriate components. Similarly, other types of tools such as utility blades, screw drivers, punches, flashlights, etc., may be constructed in accordance with the teachings of the disclosure by substituting a tool for the illustrated writing nib.

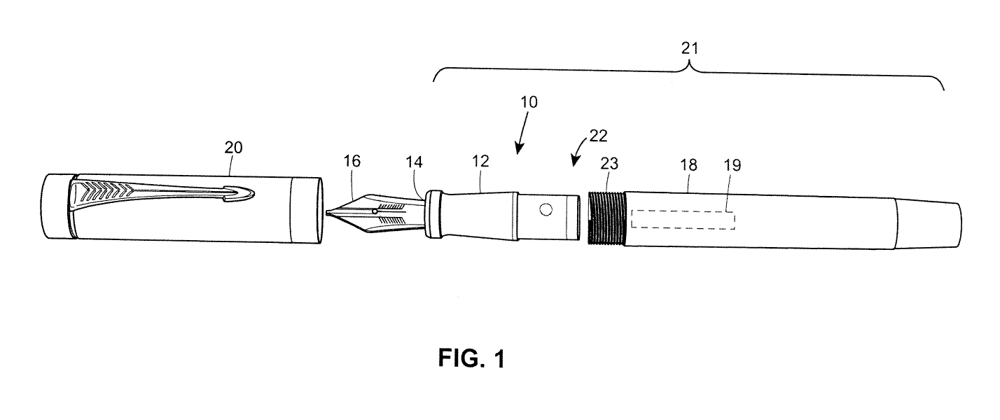

Turning to FIG. 1, the fountain pen 10 comprises an outer hollow nose section 12 having an opening 14 at one end thereof through which a writing nib 16 extends. The nose section 12 is releasably connected to a barrel housing portion 18, which houses an ink reservoir 19 for delivery of ink to the writing nib 16 (i.e., the ink reservoir can be in fluid communication with the nib when the nose section 12 and the barrel housing portion are assembled). A barrel 21 comprises the nose section 12 and the barrel housing portion 18. In the embodiment of FIG. 1, the ink reservoir 19 takes the form of a replaceable ink cartridge. A cap 20 may be releasably connected to the nose section 12 to cover the nib 16 when the nib 16 is not being used, so as to prevent ink from evaporating from the nib 16 and/or to prevent the nib 16 from becoming damaged. The nose section 12 and barrel housing portion 18 include a magnetic-mechanical connection assembly 22 that releasably secures the nose section 12 to the barrel housing portion 18, which facilitates and provides easy access to the replaceable ink cartridge, while the cap 20 may be secured to the barrel housing portion 18 with a threaded connection 23.

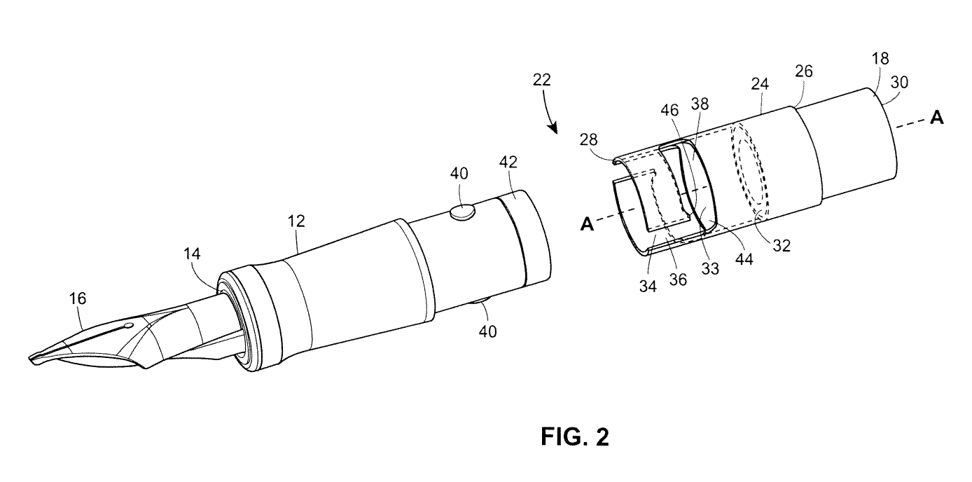

Turning now to FIG. 2, the magnetic-mechanical connection assembly 22 is illustrated in further detail. FIG. 2 illustrates the nose section 12 and a portion of the barrel housing portion 18. The barrel housing portion 18 may include a barrel connection portion 24 having one or more steps 26 having an increased diameter relative to a second end 30 of the barrel connection portion 24, with a first end 28 of the barrel connection portion 24 being large enough to fit over at least a portion of the nose section 12. The second end 30 of the barrel connection portion 24 being small enough to fit within a body of the barrel housing portion 18. In other embodiments, the barrel connection portion 24 may be integral with a body of the barrel housing portion 18 to form a single, unitary barrel housing portion 18 as long as the barrel housing portion includes the either the bayonet pins or the locking channels described further below. The nose section 12 may include a nose magnet 42 at one end and the barrel connection portion 24 may include a barrel housing magnet 32 disposed within a bore 33 formed in the first end 28 of the barrel connection portion 24. In the embodiment of FIG. 2, the nose magnet 42 and the barrel housing magnet 32 are ring-shaped magnets.

One or more cams or locking channels 34 may be formed proximate the first end 28 of the barrel connection portion 24. In the embodiment illustrated in FIG. 2, the first end 28 of the barrel connection portion 24 includes two locking channels 34. However, other embodiments may include more or less than two locking channels 34. For example, other embodiments may include one, three, four, five, six, or more locking channels. The one or more locking channels 34 may include a first portion 36 that is substantially parallel to a longitudinal axis A of the barrel connection portion 24 and a second portion 38 that is substantially perpendicular to the first portion 36. The first portion 36 and the second portion 38 may form a substantially L-shaped channel, of course other shapes may be used as well. The one or more locking channels 34 may extend completely through a thickness of the barrel connection portion 24, as illustrated in FIG. 2. In other embodiments, the one or more locking channels 34 not extend completely through the barrel connection portion 24, but rather the locking channels 34 may only extend partially through a thickness of the barrel connection portion 24, forming a channel on an inner surface of the barrel connection portion 24.

The nose section 12 may include one or more bayonet pins 40 disposed about a periphery of the barrel 12. In the embodiment of FIG. 2, two bayonet pins 40 are spaced opposite of one another on a periphery of the nose section 12. Other embodiments may include more or less than two bayonet pins 40. For example, other embodiments may include one, three, four, five, six, or more bayonet pins 40. The number of bayonet pins 40 in a given embodiment should correspond to the number of locking channels 34. The bayonet pins 40 may have a generally cylindrical shape, extending outward from an outer surface of the nose section 12, as illustrated in FIG. 2. In other embodiments, the bayonet pins 40 may have other shapes, such as rectangular, square, oval, polygon, etc. Regardless, the bayonet pins 40 are sized and shaped to fit into, and slide within, the locking channels 34. In other embodiments, the location of the bayonet pins 40 and the locking channel 34 may be reversed. For example, in other embodiments, the bayonet pins may be formed on an inner surface of the barrel housing portion 18 and the locking channels may be formed on an outer surface of the nose section 12.

The nose section 12 is secured to the barrel housing portion 18 by aligning the bayonet pins 40 with the first portion 36 of the locking channels 34. As the nose section 12 is pushed in a direction substantially parallel to the longitudinal axis A of the barrel connection portion 24, the bayonet pins 40 slide within the first portion 36 of the locking channel until the bayonet pins 40 are located at the junction 44 of the first portion 36 and the second portion 38. Due to relative positioning of the poles of the nose magnet 42 and the barrel housing magnet 32, a repelling force will be generated, which will be discussed further below. Once the bayonet pins 40 are aligned with the second portion 38, a consumer begins to twist the nose section 12 (counter clockwise in FIG. 2) so that the bayonet pins 40 begin to travel along the second portion 38 of the locking channel 34. As the nose section twisted relative to the barrel housing portion 18, poles of the nose magnet 42 and the barrel housing magnet 32 gradually align with one another so that the initial repelling force gradually decreases and eventually transitions to an attractive force, which pulls the nose section 12 towards the barrel housing portion 12. Moreover, as the poles of the nose magnet 42 and the barrel housing magnet 32 travel towards alignment the attractive force will also generate a twisting force that assists in seating the bayonet pin 40 in the second portion 38 of the locking channel 34. When the bayonet pins 40 are fully seated within the second portion 38 of the locking channel 34, opposite poles of the nose magnet 42 and the barrel housing magnet 32 will generally be aligned with one another. After the opposite poles of the nose magnet 42 and the barrel housing magnet 32 are aligned, the nose section 12 is mechanically secured to the barrel housing portion 18 with the bayonet pins 40 being disposed within the locking channels 34. Additionally, the nose section 12 is magnetically held in the secured position by the attractive force generated between the nose magnet 42 and the barrel housing magnet 32. A lip 46 may be positioned within the locking channel 34, proximate the junction 44 to prevent the bayonet pin 40 from being inadvertently slid out of the locking channel 34. Advantageously, a consumer receives a tactile indication that the nose section 12 is secured on the barrel housing 18 from the twisting and attractive forces generated by the interaction between the nose magnet 42 and the barrel housing magnet 32.

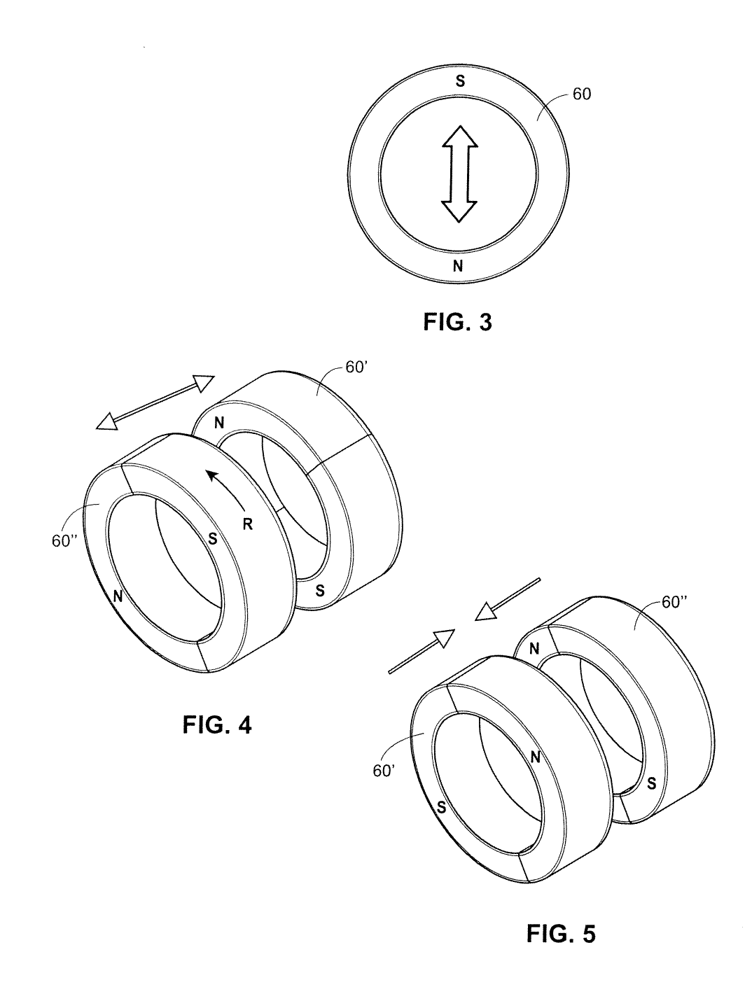

FIGS. 3-5 illustrate one embodiment of polarized ring magnets 60 that may be used for any of the nose magnets 42 and the barrel housing magnets 32 of the previous embodiments. The polarized ring magnets 60 may be formed as a ring of magnetic material having a north pole opposite a south pole. When two ring magnets 60′, 60″ are located adjacent one another, as when the nose section 12 is being attached to the barrel housing portion 18, the first ring magnet 60′ initially has the north and south poles offset with respect to the north and south poles of the second ring magnet 60″, as illustrated in FIG. 4. The orientation in FIG. 4 corresponds to a position of the nose section 12 in which the nose bayonet pins 40 are generally aligned with the first inner portion 36 of the locking channel 34. A repulsive force is produced because there is more overlap between the north poles of the first and second ring magnets 60′, 60″ (likewise for south poles of the two magnets) than there is overlap between respective north and south poles (which creates an attractive force). This repulsive force gives a consumer a non-visual (e.g., a tactile) indication that the nose section 12 is properly aligned with the barrel housing portion 18.

As the first ring magnet 60′ is rotated in the direction of R (FIG. 4), the north pole of the first ring magnet 60′ gradually becomes aligned with the south pole of the second ring magnet 60″, causing the repulsive force to gradually decrease, and eventually change to a net attractive force that results in twisting of the nose section 12 relative to the barrel housing portion 18. This net attractive force gives a consumer a non-visual (e.g., a tactile) indication that the nose section 12 is approaching a fully seated (i.e., a secured) position within the barrel housing portion 18. Moreover, this net attractive force maintains the nose section 12 in the secured position, which reduces the possibility of the nose section 12 becoming inadvertently dislodged.

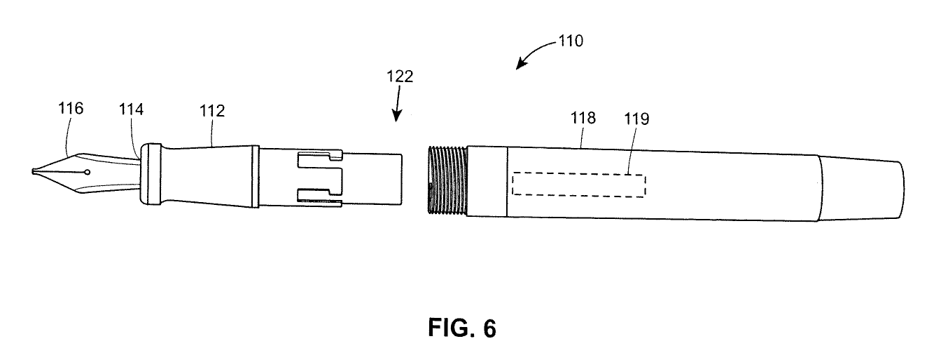

In yet another embodiment, as illustrated in FIG. 6, the writing instrument 110 comprises a hollow nose section 112 having an opening 114 at one end thereof through which a nib 116 extends. The nose section 112 is connected to a barrel housing portion 118, which houses an ink reservoir 119 for delivery of ink to the nib 116. In the embodiment of FIG. 6, the ink reservoir 119 takes the form of a replaceable cartridge. The nose section 112 is releasably secured to the barrel housing portion 118 with a magnetic-mechanical connection assembly 122.

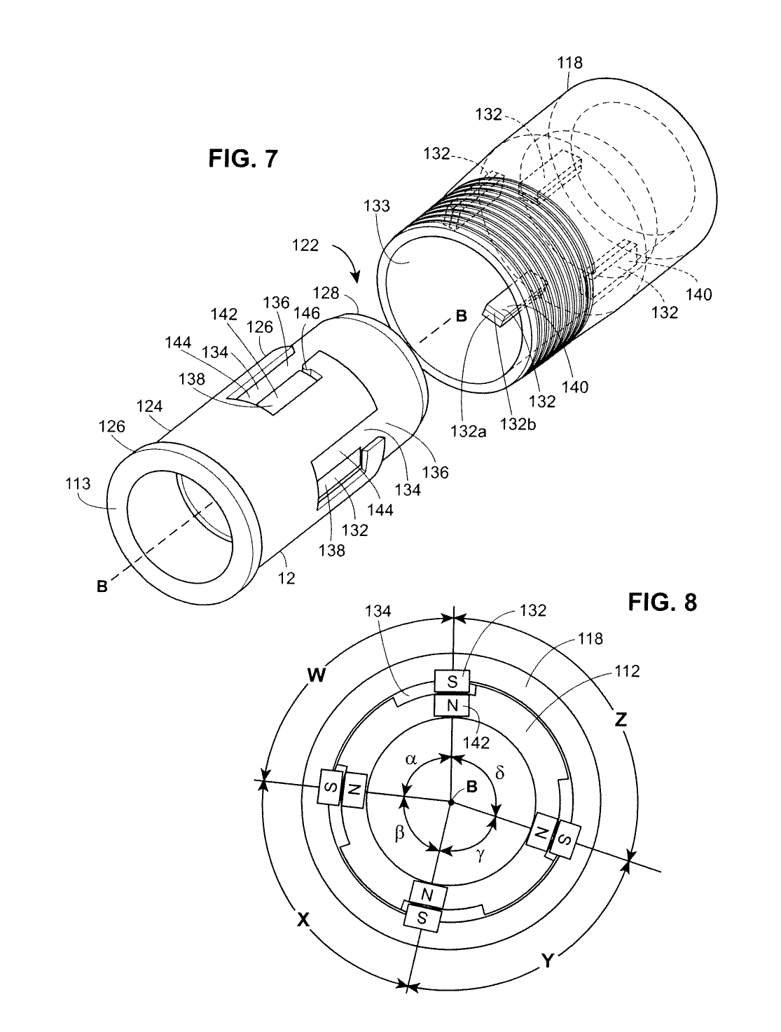

Turning now to FIG. 7, the magnetic-mechanical connection assembly 122 is illustrated in further detail. FIG. 7 illustrates a nose connection portion 124 and one end of the barrel housing portion 118. The nose connection portion 124 may include one or more steps 126 having an increased diameter relative to a second end 130, with a first end 128 of the nose connection portion 124 being small enough to fit within a portion of the barrel housing portion 118. The second end 130 of the nose connection portion 24 is large enough to fit over part of the nose section 112 so that the nose connection portion 124 is essentially an extension of the nose section 112. In other embodiments, the nose connection portion 124 may be integral with the nose section 112 forming a single, unitary nose section as long as the unitary nose section includes either the bayonet pins or the locking channels described above or below. Alternatively, the second end 130 of the nose connection portion 124 may be small enough to fit within part of the nose section 112.

The barrel housing portion 118 may include one or more barrel housing magnets 132 disposed within a hollow bore 133 of the barrel housing portion 118. The barrel housing magnets 132 may be disposed on an inner surface of the hollow bore 133, or the barrel housing magnets 132 may be embedded within a wall of the barrel housing portion 118. The barrel housing magnets 132 may take the form of a bi-polar bar magnet, as illustrated in FIG. 7, having a north pole 132a and a south pole 132b. In the embodiment of FIG. 7, the barrel housing magnets 132 also function as bayonet pins 140 that extend inwardly from an inner surface of the barrel housing portion 118. In other embodiments, the barrel housing magnets 132 and the bayonet pins 140 may be separate structures. One or more cams or locking channels 134 may be formed in the nose connection portion 124. The locking channels 134 may include a first portion 136 that is substantially parallel to a longitudinal axis B of the nose connection portion 124 and a second portion 138 that is substantially perpendicular to the first portion 136. The first portion 136 and the second portion 138 may form a substantially L-shaped channel, of course other shapes may be used. The one or more locking channels 134 may extend completely through a thickness of the nose connection portion 124, or the one or more locking channels 134 may extend only partially through a thickness of the nose connection portion 224, as illustrated in FIG. 7. The one or more locking channels 134 are shaped and sized to receive one of the bayonet pins 140 formed on an inner surface of the barrel housing portion 118 to mechanically secure the nose connection portion 124, and thus the nose section 112, to the barrel housing portion 118.

The nose section 112 may include one or more nose magnets 142 disposed about a periphery of the nose section 112 and located proximate the second portion 138 of the locking channel 134. The nose magnets 142 may have a polarity that is oriented complementary to the polarity of the barrel housing magnets 132 so that the nose magnets 142 and the barrel housing magnets 132 are magnetically attracted to one another. To releasably secure the nose connection portion 124 to the barrel housing portion 118, the first portion 136 of the locking channel 134 is aligned with a barrel housing magnet 132. As the nose connection portion 124 is moved axially substantially parallel to the longitudinal axis B, the barrel housing magnet 132 will travel along the first portion 136 of the locking channel 134. Once the barrel housing magnet 132 reaches the junction 144, magnetic attraction between the barrel housing magnet 132 and the nose magnet 142 will generate a twisting force that will rotate either the nose connection portion 124 or the barrel housing portion 118 to bring the barrel housing magnets 132 and the nose magnets 142 into general alignment with the bayonet pins 140 being seated in the second portions 138 of the locking channels 134 to provide a magnetic-mechanical lock between the nose section 112 and the barrel housing portion 118.

FIG. 8 schematically illustrates an alternative relative positioning between the nose magnets 142 and the barrel housing magnets 132 when the nose 112 is secured to the barrel housing 118. The barrel housing 118 is illustrated in FIG. 8 with the barrel housing magnets 132 being seated in the locking channels 134. In this embodiment, the there are four barrel housing magnets 132 and four nose magnets 142. For ease of reference, the barrel housing magnets 132 and the nose magnets 242 are illustrated with only a single pole. However, both the barrel housing magnets 132 and the nose magnets 242 are bi-polar. The barrel housing magnets 132 and the nose magnets 142 may not be spaced equidistantly around an inner perimeter of the barrel housing portion 118 or around an outer perimeter of the nose connection portion 124, respectively. For example, while distances W, X, and Y may be substantially equal, distance Z may be larger than any of distances W, X, and Y. Likewise, angular orientations may not be equal between each of the barrel magnets 142 and between each of the shell magnets 232. For example, three angles α, β, and γ may be substantially equal (e.g., approximately 85 degrees) while angle δ may be larger than angles α, β, and γ (e.g., approximately 105 degrees). This unequal spacing of the nose magnets 142 and the barrel housing magnets 132 provides a single radial locking position. In other words, there is only one radial position that will allow nose section 112 to be secured to the barrel housing 118. This single radial position may be beneficial to align graphics or other features on the nose section 112 with graphics or other features on the barrel housing portion 118.

As illustrated in FIG. 8, the barrel housing magnets 132 and the nose magnets 142 may take the form of bar magnets having a north pole and a south pole. The barrel housing magnets 132 may have magnetic fields oriented in a complimentary direction to magnetic fields of the nose magnets 142. For example, the barrel housing magnets 132 may have a south pole oriented radially inward and a north pole oriented radially outward. Likewise, the nose magnets 142 may have the north pole oriented radially outward and the south pole oriented radially inward. In other embodiments, the barrel housing magnets 132 and the nose magnets 142 may have a north pole oriented radially inward and a south pole oriented radially outward, essentially opposite of the orientations illustrated in FIG. 8. In yet other embodiments, the barrel housing magnets 132 and the nose magnets 142 may have varying orientations as long as adjacent magnets have complimentary orientations when the nose section 112 is in a secured position on the barrel housing portion 118 with the barrel housing magnets 132 seated in the second portions 138 of the locking channels 134 so that an attractive force is generated between the barrel housing magnets 132 and the nose magnets 142.

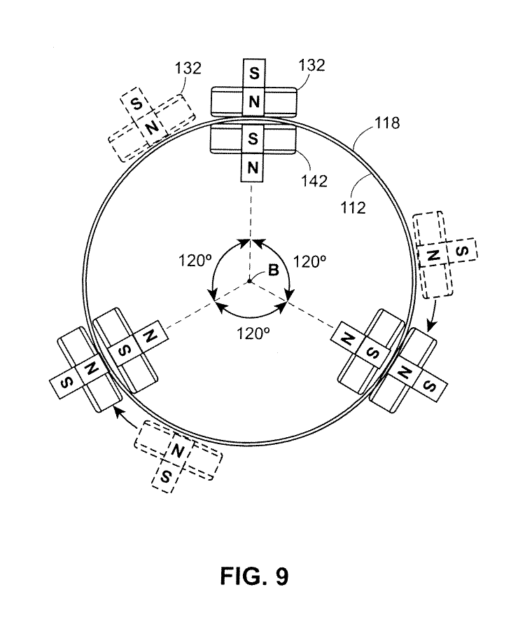

FIG. 9 schematically illustrates an alternative relative positioning between the barrel housing magnets 132 and the shell magnets 142 as the nose section 112 is secured to the barrel housing portion 118. Initially, the barrel housing magnets 132 are not aligned with the nose magnets 142, the initial position of the barrel housing magnets 132 is represented by the barrel housing magnets 132 illustrated in phantom. Once the bayonet pins 140 are aligned with the second portions 138 of the locking channels 134, magnetic attraction between the barrel housing magnets 132 and the nose magnets 142 produces a twisting force that rotates the nose section 112 relative to the barrel housing portion 118, or vice versa. Once the barrel housing magnets 132 and the nose magnets 142 are aligned adjacent to one another, as illustrated by the barrel housing magnets 132 in solid lines in FIG. 9, the bayonet pins 140 and locking channels 134 magnetically and mechanically secure the nose section 112 to the barrel housing portion 118, as described above. As illustrated in FIG. 9, the barrel housing magnets 132 and the nose magnets 142 may take the form of disc magnets having a north pole and a south pole, in this embodiment. The barrel housing magnets 132 may have their magnetic fields oriented in a complimentary direction to magnetic fields of the nose magnets 142. For example, the barrel housing magnets 132 may have a south pole oriented radially outward and a north pole oriented radially inward. Likewise, the nose magnets 142 may have the north pole oriented radially inward and the south pole oriented radially outward, as illustrated in FIG. 9. In other embodiments, the barrel housing magnets 132 and the nose magnets 142 may have a north pole oriented radially outward and a south pole oriented radially inward, essentially opposite of the orientations illustrated in FIG. 9. In yet other embodiments, the barrel housing magnets 132 and the nose magnets 142 may have varying orientations as long as adjacent magnets (when aligned upon securing the respective components to one another) have complimentary orientations when the nose section 112 is in a secured position with the bayonet pins 140 seated in the second portions 138 of the locking channels 134 so that an attractive force is generated between the barrel housing magnets 132 and the nose magnets 142. Removal of the nose section 112 may be accomplished in an opposite order from attachment of the nose section 112 described above.

In one embodiment (FIG. 9), the nose section 112 may include three nose magnets 142. The three nose magnets 142 may be spaced about a periphery of the nose section 112 and separated from one another by approximately 120 degrees. In other embodiments other combinations of nose magnets 142 may be used. For example, other embodiments may include one, two, four, five, six, or more nose magnets 142. In yet other embodiments, the nose magnets 142 may be spaced at irregular intervals about a periphery of the nose section 112, for example as illustrated in FIG. 8. In yet other embodiments, the nose magnets 142 may be embedded within the nose section 112 as long as the magnetic field generated by the nose magnets 142 is sufficient to produce a twisting force when interacting with the barrel housing magnets 132.

Any suitable magnet may be used to provide the nose magnets 42 and/or the barrel housing magnets 32. In one embodiment the nose magnets 42 and/or the barrel housing magnets 32 may comprise neodymium iron boron disc super magnets having a field strength of approximately 400 g. In other embodiments, various combinations of disc magnets may be arranged to produce an initial repulsive force followed by a twist-attraction, as described above.

In yet other embodiments the nose magnets 42 and/or the barrel housing magnets 32 may comprise diametrically polarized ring super magnets, which can produce either a repulsive or attractive force when a pair of such magnets are brought together depending on relative orientations of the respective north and south poles, as discussed above. Of course, other magnets can also be positioned to produce a repulsive force when the nose section 12 is properly aligned with the barrel housing portion 18, which transitions to a net attractive force that results in twisting of the nose section 12 relative to the barrel housing portion 18.

In yet other embodiments the nose magnets 132 and/or the barrel housing magnets 32 may comprise a magnetic plastic resin. For example, the plastic resin can be infused with magnetic material and then subjected to a magnetic field before the resin sets in order to orient particles of the magnetic material in the same direction, thereby imparting magnetic properties to the plastic resin.

In the disclosed embodiments, the magnetic attractions are used to provide a seating force and the attractive force between magnets is not solely relied upon as a connecting force between the barrel and the shell but rather a mechanical interaction provides a significant portion of the connecting force so that the overall connecting force is greater than the magnetic force alone.

The disclosure is not limited to a fountain pen. The disclosure could be applied to virtually any writing instrument or tool, such as utility blades, flashlights, screw drivers, or other similar instruments. The features of the invention disclosed in the description, drawings and claims can be individually or in various combinations for the implementation of the different embodiments of the invention.

1. An instrument comprising:
a nose section having a hollow channel and a first opening at one end of the hollow channel;
a barrel housing portion having an interior, the nose section being at least partially disposed within the interior of the barrel housing portion; and
a magnetic-mechanical connection assembly between the nose section and the barrel housing portion that provides magnetic and mechanical force to secure the nose section to the barrel housing portion, the magnetic-mechanical connection assembly including at least one bayonet pin disposed on one of the nose section and the barrel housing portion and at least one locking channel disposed on the other of the nose section and the barrel housing portion.

2. The instrument of claim 1 wherein the magnetic-mechanical connection assembly includes a plurality of nose magnets disposed about a periphery of the nose section.

3. The instrument of claim 2, wherein at least one nose magnet is a ring magnet.

4. The instrument of claim 2 wherein the magnetic-mechanical connection assembly includes a plurality of nose bayonet pins disposed about an outer periphery of the nose section.

5. The instrument of claim 4 wherein at least one nose magnet is integrally formed with at least one nose bayonet pin.

6. The instrument of claim 4 wherein the plurality of nose bayonet pins are spaced equidistantly from one another.

7. The instrument of claim 2 wherein the plurality of nose magnets are spaced equidistantly from one another.

8. The instrument of claim 7, wherein the plurality of nose magnets includes three nose magnets, each nose magnet being separated radially by approximately 120 degrees from the other nose magnets.

9. The instrument of claim 1 wherein the magnetic-mechanical connection assembly includes a plurality of barrel housing magnets disposed about an inner surface of the barrel housing portion.

10. The instrument of claim 9, wherein at least one barrel housing magnet is a ring magnet.

11. The instrument of claim 1 wherein the magnetic-mechanical connection assembly includes a plurality of locking channels disposed about an inner surface of the barrel housing portion.

12. The instrument of claim 1 wherein the magnetic-mechanical connection assembly includes a plurality of locking channels disposed about an outer surface of the nose section.

13. The instrument of claim 12 wherein at least one locking channel includes a first portion that is substantially parallel to a longitudinal axis of the nose section and a second portion that is substantially perpendicular to the first portion.

14. The instrument of claim 12 wherein the at least one locking channel includes a lip.

15. A writing instrument comprising:
a nose section having an opening at one end;
a writing nib extending through the opening;
a barrel housing portion connected to the nose section opposite of the writing nib, the barrel housing portion having an ink reservoir for holding ink to be delivered to the writing nib; and
a magnetic-mechanical connection assembly that provides connection force for releasably connecting the nose section to the barrel housing portion;
wherein the magnetic-mechanical connection assembly includes at least one nose magnet disposed on the nose section, at least one barrel housing magnet disposed on the barrel housing portion, at least one locking channel formed in an inner surface of the barrel housing portion, and at least one bayonet pin formed on an outer surface of the nose section, the bayonet pin being sized and shaped to fit within the locking channel to mechanically secure the nose section to the barrel housing portion, such that the barrel housing magnets and the nose magnets are aligned to provide an attractive force therebetween.

16. The writing instrument of claim 15 wherein the at least one nose magnet is a ring magnet.

17. The writing instrument of claim 15 wherein the at least one barrel housing magnet is a ring magnet.

18. The writing instrument of claim 15 wherein the at least one nose magnet and the at least one barrel housing magnet interact to produce an initial repelling force when the at least one bayonet pin is aligned with a first portion of the at least one locking channel and the at least one barrel housing magnet and the at least one nose magnet interact to produce an attractive force when the bayonet pin is seated within a second portion of the at least one locking channel.

19. The writing instrument of claim 15 further comprising a lip within the at least one locking channel.

20. The writing instrument of claim 15 wherein one of the at least one nose magnet and the at least one barrel housing magnet comprise a magnetic plastic material.
